(19) United States
(12) Patent Application Publication
(10) Pub. No.: US 2014/0146023 A1
(43) Pub. Date: May 29, 2014

(54) DISPLAY APPARATUS AND METHOD OF DISPLAYING THREE-DIMENSIONAL IMAGE USING THE SAME

(71) Applicant: SAMSUNG DISPLAY CO., LTD., Yongin City (KR)

(72) Inventors: Goro HAMAGISHI, Hwaseong-si (KR); Se-Joon OH, Suwon-si (KR); Sang-Min JEON, Yongin-si (KR); Kyung-Ho JUNG, Seongnam-si (KR)

(73) Assignee: Samsung Display Co., Ltd., Yongin City (KR)

(21) Appl. No.: 13/859,648

(22) Filed: Apr. 9, 2013

(30) Foreign Application Priority Data
Nov. 28, 2012 (KR) 10-2012-0135815

(51) Int. Cl. G09G 3/36

(52) U.S. Cl. CPC G09G 3/36
USPC 345/204; 345/87

(57) ABSTRACT

A display apparatus includes a display panel, a barrier part, a display panel driver and a barrier driver. The display panel includes a plurality of pixels. The barrier part is disposed on the display panel. The barrier part generates N viewpoint images using a plurality of barriers selectively transmitting and blocking a light. N is a natural number. The display panel driver provides image data to the display panel. The barrier driver controls the barrier part such that the different barriers have transmitting statuses in a first subframe and a second subframe.

### CROSS-REFERENCE TO RELATED APPLICATION

This application claims priority to Korean Patent Application No. 10-2012-0135815, filed on Nov. 28, 2012, and all the benefits accruing therefrom under 35 U.S.C. §119, the contents of which are herein incorporated by reference in their entireties.

### BACKGROUND OF THE INVENTION

1. Field of the Invention

Exemplary embodiments of the present invention relate to a display apparatus and a method of displaying a three-dimensional (“3D”) image using the display apparatus. More particularly, exemplary embodiments of the present invention relate to a display apparatus improving a display quality and a method of displaying a 3D image using the display apparatus.

2. Description of the Related Art

Generally, a display apparatus displays a two-dimensional (“2D”) image. Recently, as a demand for a 3D display in video game and movie industries has been increasing, 3D display apparatuses have been developed to display the 3D image.

Generally, a stereoscopic image display apparatus displays the 3D image using a binocular parallax between two eyes of a human. For example, as two eyes of a human are spaced apart from each other, images viewed from different angles are inputted to a human brain. The human brain mixes the images so that a viewer may recognize the 3D image.

The stereoscopic image display apparatus may be divided into a stereoscopic type and an auto-stereoscopic type depending on whether or not a viewer needs extra glasses. The stereoscopic type may include an anaglyph type and a shutter glass type and so on. The auto-stereoscopic type may include a lenticular type, a barrier type, a liquid crystal lens type and a liquid crystal barrier type.

The auto-stereoscopic type display apparatus generates a plurality of images having various viewpoints. However, a resolution of the 3D image decreases according to the number of the viewpoints. In addition, a crosstalk which means that an image corresponding to other viewpoints is shown to an eye of the viewer may be occurred so that a display quality of the 3D image may be deteriorated.

### BRIEF SUMMARY OF THE INVENTION

Exemplary embodiments of the present invention provide a display apparatus to improve a display quality of a three-dimensional (“3D”) image.

Exemplary embodiments of the present invention also provide a method of displaying the 3D image using the display apparatus.

In an exemplary embodiment of a display apparatus according to the present invention, the display apparatus includes a display panel, a barrier part, a display panel driver and a barrier driver. The display panel includes a plurality of pixels. The barrier part is disposed on the display panel. The barrier part generates N viewpoint images using a plurality of barriers selectively transmitting and blocking a light. N is a natural number. The display panel driver provides image data to the display panel. The barrier driver controls the barrier part such that the different barriers have transmitting statuses in a first subframe and a second subframe.

In an exemplary embodiment, the barrier part may include a unit barrier group having N barriers. A pitch of the unit barrier group may be P. A pitch of the barrier may be equal to or greater than P/N.

In an exemplary embodiment, the barrier having the transmitting status during the second subframe may be spaced apart from the barrier having the transmitting status during the first subframe by an integer multiple of the pitch of the barrier in the unit barrier group.

In an exemplary embodiment, when a single frame is divided into M subframes, M being a natural number, the barrier having the transmitting status during the second subframe may be spaced apart from the barrier having the transmitting status during the first subframe by an integer multiple of the pitch of the barrier in the unit barrier group. The integer may be a closest integer to N/M.

In an exemplary embodiment, when a single frame is divided into M subframes, M being a natural number, positions of barriers in the unit barrier group having transmitting statuses in the frame may be same in consecutive frames.

In an exemplary embodiment, when a single frame is divided into M subframes, M being a natural number, positions of barriers in the unit barrier group having transmitting statuses in the frame may be different from each other in consecutive frames.

In an exemplary embodiment, the barrier part may be a liquid crystal barrier module which is turned off in a two-dimensional mode and turned on in a three-dimensional mode.

In an exemplary embodiment, the barrier part may be a step barrier including a barrier having the transmitting status in a first row, a barrier having the transmitting status in a second row. A position of the barrier having the transmitting status in the first row may not correspond to a position of the barrier having the transmitting status in the second row.

In an exemplary embodiment of a method of displaying a 3D image, the method includes providing image data to a display panel including a plurality of pixels and controlling a barrier part including a plurality of barriers selectively transmitting and blocking light such that the different barriers have transmitting statuses according to a first subframe and a second subframe to generate N viewpoint images, N being a natural number.

In an exemplary embodiment, the barrier part may include a unit barrier group having N barriers. A pitch of the unit barrier group may be P. A pitch of the barrier may be equal to or greater than P/N.

In an exemplary embodiment of a display apparatus according to the present invention, the display apparatus includes a display panel, a lens part, a display panel driver and a lens driver. The display panel includes a plurality of pixels. The lens part is disposed on the display panel. The lens part generates N viewpoint images using a plurality of lenses refracting a light. N is a natural number. The display panel driver provides image data to the display panel. The lens driver shifting a focal point of the lens part according to a first subframe and a second subframe.

In an exemplary embodiment, a pitch of the lens may be P. The lens may be disposed at a position during the second subframe which is shifted from a position of the lens during the first sub frame by P/N.

In an exemplary embodiment, a pitch of the lens may be P. The lens may be disposed at a position during the second subframe which is shifted from a position of the lens during the first subframe by an integer multiple of P/N.

In an exemplary embodiment, when a single frame is divided into M subframes, M being a natural number, the lens may be disposed at a position during the second subframe which is moved from a position of the lens during the first subframe by an integer multiple of P/N. The integer may be a closest integer to N/M.

In an exemplary embodiment, when a single frame is divided into M subframes, M being a natural number, positions of the lens part in the frame may be same in consecutive frames.

In an exemplary embodiment, when a single frame is divided into M subframes, M being a natural number, positions of the lens part in the frame may be different from each other in consecutive frames.

In an exemplary embodiment, the lens part may be a liquid crystal lens module which is turned off in a two-dimensional mode and turned on in a three-dimensional mode.

In an exemplary embodiment, the lenses of the lens part may be inclined with respect to a direction of a pixel column.

In an exemplary embodiment of a method of displaying a 3D image, the method includes providing image data to a display panel including a plurality of pixels and controlling a lens part including a plurality of lenses refracting a light such that a focal point of the lenses are shifted in a first subframe and a second subframe to generate N viewpoint images, N being a natural number.

In an exemplary embodiment, a pitch of the lens may be P. The lens may be disposed at a position during the second subframe which is shifted from the position of the lens during the first sub frame by P/N.

In an exemplary embodiment, a pitch of the lens may be P. The lens may be disposed at a position during the second subframe which is shifted from a position of the lens during the first subframe by an integer multiple of P/N.

According to the display apparatus and the method of displaying the 3D image using the display apparatus, the display panel and the light converting element are driven in a time division driving method so that a resolution of the 3D image may increase and a crosstalk may be prevented. Thus, a display quality of the 3D image may be improved.

### BRIEF DESCRIPTION OF THE DRAWINGS

The above and other features and advantages of the present invention will become more apparent by describing in detailed exemplary embodiments thereof with reference to the accompanying drawings, in which:

FIG. 1 is a block diagram illustrating a display apparatus according to an exemplary embodiment of the present invention;

FIG. 2 is a conceptual diagram illustrating a method of displaying a three-dimensional (“3D”) image using a display panel and a light converting element of FIG. 1;

FIG. 3 is a graph illustrating a luminance profile of the 3D image displayed using the display panel and the light converting element of FIG. 1 according to viewpoints;

FIG. 4A is a conceptual diagram illustrating a method of displaying the 3D image using the display panel and the light converting element of FIG. 1 during a first subframe;

FIG. 4B is a conceptual diagram illustrating a method of displaying the 3D image using the display panel and the light converting element of FIG. 1 during a second subframe;

FIG. 5 is a conceptual diagram illustrating an operation of the light converting element of FIG. 1 during the first and second subframes;

FIG. 6A is a conceptual diagram illustrating a method of displaying a 3D image using a display panel and a light converting element according to an exemplary embodiment during a first subframe;

FIG. 6B is a conceptual diagram illustrating a method of displaying the 3D image using the display panel and the light converting element of FIG. 6A during a second subframe;

FIG. 7 is a conceptual diagram illustrating an operation of the light converting element of FIG. 6A during the first and second subframes;

FIG. 8A is a conceptual diagram illustrating a method of displaying a 3D image using a display panel and a light converting element according to an exemplary embodiment during a first subframe;

FIG. 8B is a conceptual diagram illustrating a method of displaying the 3D image using the display panel and the light converting element of FIG. 8A during a second subframe;

FIG. 8C is a conceptual diagram illustrating a method of displaying the 3D image using the display panel and the light converting element of FIG. 8A during a third subframe;

FIG. 9 is a conceptual diagram illustrating an operation of the light converting element of FIG. 8A during the first to third subframes;

FIG. 10A is a conceptual diagram illustrating a method of displaying a 3D image using a display panel and a light converting element according to an exemplary embodiment during a first subframe;

FIG. 10B is a conceptual diagram illustrating a method of displaying the 3D image using the display panel and the light converting element of FIG. 10A during a second subframe;

FIG. 10C is a conceptual diagram illustrating a method of displaying the 3D image using the display panel and the light converting element of FIG. 10A during a third subframe;

FIG. 11 is a conceptual diagram illustrating an operation of the light converting element of FIG. 10A during the first to third subframes;

FIG. 12 is a conceptual diagram illustrating a displayed image using a display panel and a light converting element according to an exemplary embodiment;

FIG. 13 is a conceptual diagram illustrating a method of displaying a 3D image using a display panel and a light converting element according to an exemplary embodiment;

FIG. 14 is a graph illustrating a luminance profile of the 3D image displayed using the display panel and the light converting element of FIG. 13 according to viewpoints;

FIG. 15A is a conceptual diagram illustrating a method of displaying a 3D image using a display panel and a light converting element of FIG. 13 during a first subframe;

FIG. 15B is a conceptual diagram illustrating a method of displaying the 3D image using the display panel and the light converting element of FIG. 13 during a second subframe;

FIG. 16 is a conceptual diagram illustrating an operation of the light converting element of FIG. 13 during the first and second subframes; and

FIG. 17 is a perspective view illustrating a light converting element according to an exemplary embodiment.

### DETAILED DESCRIPTION OF THE INVENTION

Hereinafter, exemplary embodiments of the present invention will be described in further detail with reference to the accompanying drawings.

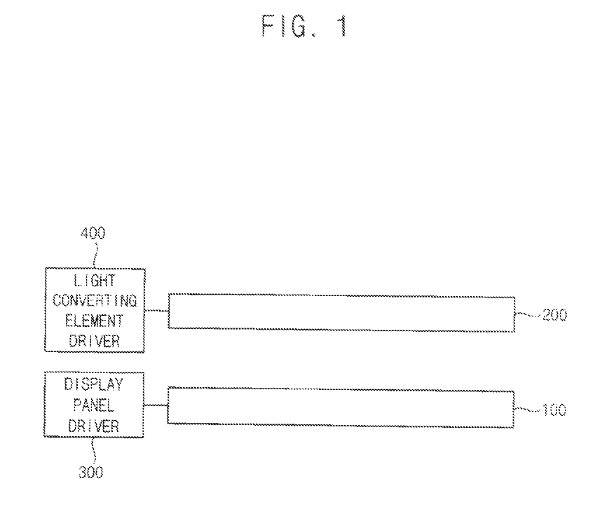

FIG. 1 is a block diagram illustrating a display apparatus according to an exemplary embodiment of the present invention.

Referring to FIG. 1, the display apparatus includes a display panel 100, a light converting element 200, a display panel driver 300 and a light converting element driver 400.

The display panel 100 displays an image. The display panel 100 may include a first substrate, a second substrate facing the first substrate and a liquid crystal layer disposed between the first and the second substrates.

The display panel 100 includes a plurality of pixels. Each pixel includes a plurality of subpixels. For example, the pixel may include a red subpixel, a green subpixel and a blue subpixel.

The display panel 100 includes a plurality of gate lines and a plurality of data lines. The subpixels are connected to the gate lines and the data lines. The gate lines extend in a first direction. The date lines extend in a second direction crossing the first direction.

Each subpixel includes a switching element and a liquid crystal capacitor electrically connected to the switching element. The subpixel may further include a storage capacitor. The subpixels are disposed in a matrix form. The switching element may be a thin film transistor.

The gate lines, the data lines, pixel electrodes and storage electrodes may be disposed on the first substrate. A common electrode may be disposed on the second substrate.

The light converting element 200 is disposed on the display panel 100. The light converting element 200 generates N viewpoint images based on an image on the display panel 100. Herein, N is a natural number. For example, the light converting element 200 may transmit the image on the subpixel of the display panel 100 to the respective viewpoints so that the viewer may recognize a three dimensional image.

For example, the light converting element 200 may be a barrier part including a plurality of barriers. The barriers selectively transmit and block a light. The barriers may selectively transmit and block the image on the subpixel of the display panel 100 so that the barriers generate N viewpoint images. The barriers may be disposed along a first direction. The barriers may extend in a second direction crossing the first direction.

For example, the light converting element 200 may be a lens part including a plurality of lenticular lenses. The lenticular lenses refract light. The lenticular lenses may refract the image on the subpixel of the display panel 100 so that the lenticular lenses generate N viewpoint images. The lenticular lenses may be disposed along a first direction. The lenticular lenses may extend in a second direction crossing the first direction.

For example, the light converting element 200 may be a barrier module which is operated according to a driving mode including a 2D mode and a 3D mode. For example, the light converting element 200 may be a liquid crystal barrier module. The barrier module is turned on or off in response to the driving mode. For example, the barrier module is turned off in the 2D mode so that the display apparatus displays a 2D image. The barrier module is turned on in the 3D mode so that the display apparatus displays a 3D image.

The barrier module may include a first barrier substrate, a second barrier substrate facing the first barrier substrate and a barrier liquid crystal layer disposed between the first and the second barrier substrates.

For example, the light converting element 200 may be a lens module which is operated according to the driving mode including the 2D mode and the 3D mode. For example, the light converting element 200 may be a liquid crystal lens module. The lens module is turned on or off in response to the driving mode. For example, the lens module is turned off in the 2D mode so that the display apparatus displays the 2D image. The lens module is turned on in the 3D mode so that the display apparatus displays the 3D image.

The lens module includes a first lens substrate, a second lens substrate facing the first lens substrate and a lens liquid crystal layer disposed between the first and second lens substrates.

Alternatively, the light converting element 200 may include a plurality of prisms changing a path of the light. Alternatively, the light converting element 200 may include a holographic element changing a path of the light.

The display panel driver 300 is connected to the display panel 100 to drive the display panel 100. The display panel driver 300 may be operated in a time division driving method. The display panel driver 300 provides image data to the display panel 100. For example, the display panel driver 300 may provide first image data to the display panel 100 during a first subframe and second image data to the display panel 100 during a second subframe. For example, the second image data are different from the first image data. Alternatively, the second image data are the same as the first image data.

The display panel driver 300 includes a timing controller, a gate driver, a data driver and a gamma reference voltage generator.

The timing controller receives input image data and an input control signal from an external apparatus. The input image data may include red image data, green image data and blue image data. The input control signal may include a master clock signal, a data enable signal, a vertical synchronizing signal and a horizontal synchronizing signal.

The timing controller generates a first control signal, a second control signal and a data signal based on the input image data and the input control signal.

The timing controller generates the first control signal to control a driving timing of the gate driver based on the input control signal, and outputs the first control signal to the gate driver.

The timing controller generates the second control signal to control a driving timing of the data driver based on the input control signal, and outputs the second control signal to the data driver. The timing controller generates the data signal based on the input image data, and outputs the data signal to the data driver.

The gate driver generates gate signals for driving the gate lines in response to the first control signal. The gate driver sequentially outputs the gate signals to the gate lines.

The gamma reference voltage generator generates a gamma reference voltage. The gamma reference voltage generator provides the gamma reference voltage to the data driver. The gamma reference voltages have values corresponding to the data signal.

The data driver converts the data signal into data voltages having analog types using the gamma reference voltage. The data driver outputs the data voltages to the data lines.

The light converting element driver 400 is connected to the light converting element 200 and drives the light converting element 200. The light converting element driver 400 may be operated in a time division driving method. The light converting element driver 400 controls the light converting element 200 such that the light converting element 200 has different statuses in the first subframe and the second subframe.

For example, when the light converting element 200 is a barrier part, the light converting element driver 400 is a barrier driver. The barrier driver 400 controls the barrier part 200 such that different barriers have transmitting statuses in the first subframe and the second subframe.

For example, when the light converting element 200 is a lens part, the light converting element driver 400 is a lens driver. The lens driver 400 controls the lens part 200 such that the lenses have a different focal point in the first subframe and the second subframe.

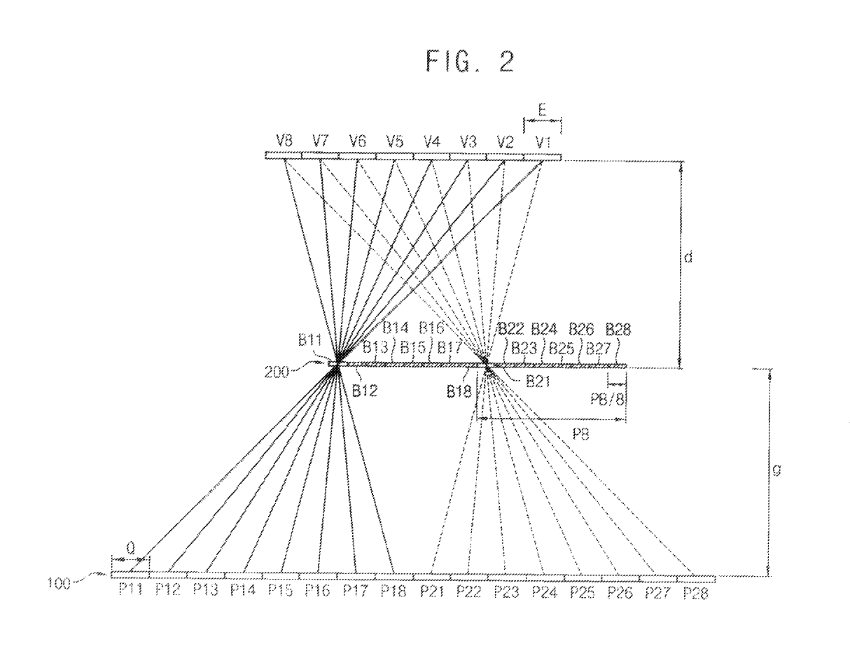

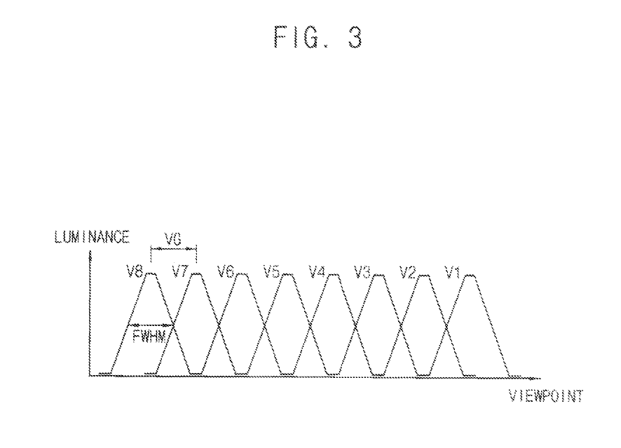

FIG. 2 is a conceptual diagram illustrating a method of displaying the 3D image using the display panel 100 and the light converting element 200 of FIG. 1. FIG. 3 is a graph illustrating a luminance profile of the 3D image displayed using the display panel 100 and the light converting element 200 of FIG. 1 according to viewpoints.

Referring to FIGS. 1 to 3, the light converting element 200 is the barrier part and the light converting element driver 400 is the barrier driver in the present exemplary embodiment.

The barrier part 200 generates N viewpoint images using a plurality of barriers. In the present exemplary embodiment, N is eight. The display panel 100 and the barrier part 200 are driven in a time division driving method. For example, a single frame is divided into M subframes in the time division driving method. Herein, M is a natural number. In the present exemplary embodiment, M is two. A subframe is a time period in which different images are inputted to an eye of the viewer within a frame. Each subframe may comprise an image having different portion of the same image in the frame or each subframe may comprise a different image in the frame.

The display panel 100 includes a plurality of subpixels. In FIG. 2, sixteen subpixels P11, P12, P13, P14, P15, P16, P17, P18, P21, P22, P23, P24, P25, P26, P27 and P28 are illustrated for convenience of explanation.

The barrier part 200 is disposed on the display panel 100. The barrier part 200 includes a unit barrier group including eight barriers (N=8). A pitch of the unit barrier group is PB. A pitch of the single barrier is equal to or greater than PB/8. For example, the pitch of the single barrier is PB/8. The eight barriers in the unit barrier group may be independently driven.

Among the eight barriers in the unit barrier group of barrier part 200, one barrier may have a transmitting status and seven barriers may have blocking statuses.

The image displayed on the subpixel of the display panel 100 is transmitted to viewpoint areas V1, V2, V3, V4, V5, V6, V7 and V8 through the barrier having the transmitting status.

For example, an image on a first subpixel P11 is transmitted to a first viewpoint area V1 through a first barrier B11 of a first unit barrier group. An image on a second subpixel P12 is transmitted to a second viewpoint area V2 through the first barrier B11 of the first unit barrier group. An image on a third subpixel P13 is transmitted to a third viewpoint area V3 through the first barrier B11 of the first unit barrier group. An image on a fourth subpixel P14 is transmitted to a fourth viewpoint area V4 through the first barrier B11 of the first unit barrier group. An image on a fifth subpixel P15 is transmitted to a fifth viewpoint area V5 through the first barrier B11 of the first unit barrier group. An image on a sixth subpixel P16 is transmitted to a sixth viewpoint area V6 through the first barrier B11 of the first unit barrier group. An image on a seventh subpixel P17 is transmitted to a seventh viewpoint area V7 through the first barrier B11 of the first unit barrier group. An image on an eighth subpixel P18 is transmitted to an eighth viewpoint area V8 through the first barrier B11 of the first unit barrier group.

In a similar way, an image on a ninth subpixel P21 is transmitted to the first viewpoint area V1 through a first barrier B21 of a second unit barrier group. An image on a tenth subpixel P22 is transmitted to the second viewpoint area V2 through the first barrier B21 of the second unit barrier group. An image on an eleventh subpixel P23 is transmitted to the third viewpoint area V3 through the first barrier B21 of the second unit barrier group. An image on a twelfth subpixel P24 is transmitted to the fourth viewpoint area V4 through the first barrier B21 of the second unit barrier group. An image on a thirteenth subpixel P25 is transmitted to the fifth viewpoint area V5 through the first barrier B21 of the second unit barrier group. An image on a fourteenth subpixel P26 is transmitted to the sixth viewpoint area V6 through the first barrier B21 of the second unit barrier group. An image on a fifteenth subpixel P27 is transmitted to the seventh viewpoint area V7 through the first barrier B21 of the second unit barrier group. An image on a sixteenth subpixel P28 is transmitted to then eighth viewpoint area V8 through the first barrier B21 of the second unit barrier group.

When a distance between the display panel 100 and the barrier part 200 is g, a proper distance from the barrier part 200 to the viewer is d, a pitch of the subpixel of the display panel 100 is Q, a pitch of the unit barrier group is PB and a width of the viewpoint area at the proper distance from the barrier part 200 to the viewer d is E, the display apparatus satisfies following Equations 1 and 2.

PB:d=8Q:(d+g) [Equation 1]

E:d=Q:g [Equation 2]

For example, the proper distance d may be determined that the width of the viewpoint area E at the proper distance is substantially equal to a distance between two eyes of the viewer.

FIG. 3 represents a luminance profile according to the viewpoint of the 3D image. The luminance of the image corresponding to the first viewpoint has the maximum value at a central portion of the first viewpoint area V1. The luminance of the image corresponding to the first viewpoint decreases as a position is deviated from the central portion of the first viewpoint area V1. The luminance of the image corresponding to the first viewpoint may be about zero at a central portion of the second viewpoint area V2 adjacent to the first viewpoint area V1.

The luminance of the image corresponding to the second viewpoint has the maximum value at the central portion of the second viewpoint area V2. The luminance of the image corresponding to the second viewpoint decreases as a position is deviated from the central portion of the second viewpoint area V2. The luminance of the image corresponding to the second viewpoint may be about zero at a central portion of the first viewpoint area V1 and a central portion of the third viewpoint area V3 which are adjacent to the second viewpoint area V2.

The luminance of the image corresponding to the third viewpoint has the maximum value at the central portion of the third viewpoint area V3. The luminance of the image corresponding to the third viewpoint decreases as a position is deviated from the central portion of the third viewpoint area V3. The luminance of the image corresponding to the third viewpoint may be about zero at the central portion of the second viewpoint area V2 and a central portion of the fourth viewpoint area V4 which are adjacent to the third viewpoint area V3.

A viewpoint gap VG is defined as a distance between central points of adjacent viewpoint areas. In addition, a full width at half maximum (“FWHM”) of the luminance means a width of a spectrum of the luminance profile at which a luminance value becomes a half of the maximum luminance.

As a ratio of the FWHM of the luminance to the viewpoint gap VG increases, a probability of a crosstalk increases. In the present exemplary embodiment, although the display panel 100 and the light converting element 200 are driven in the time division driving method, the viewpoint gap VG is not changed. Thus, the display apparatus according to the exemplary embodiments of the invention has a relatively low value of the ratio. Thus, the crosstalk may be prevented.

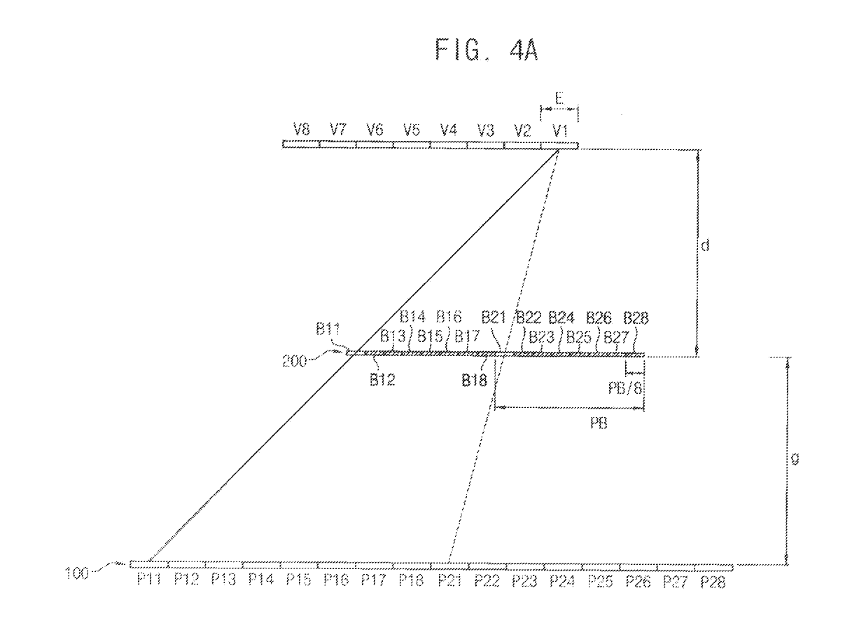

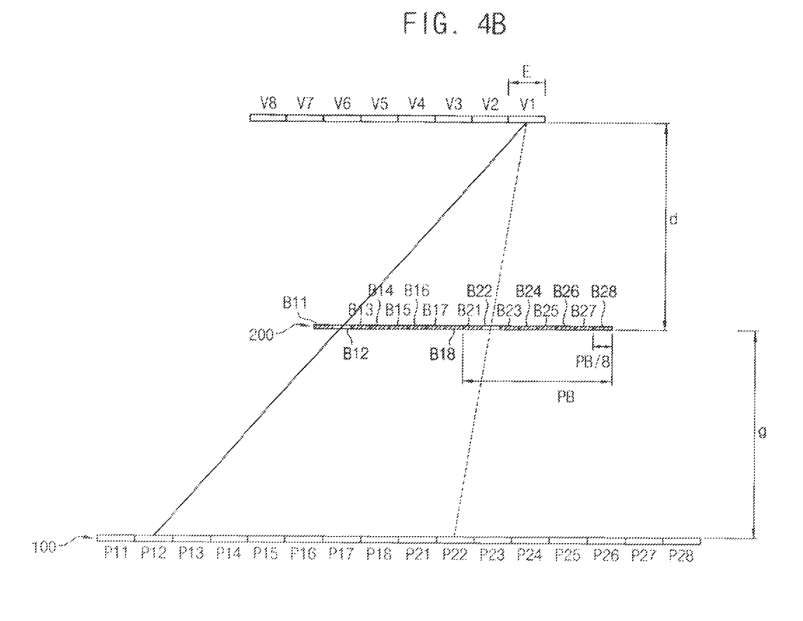

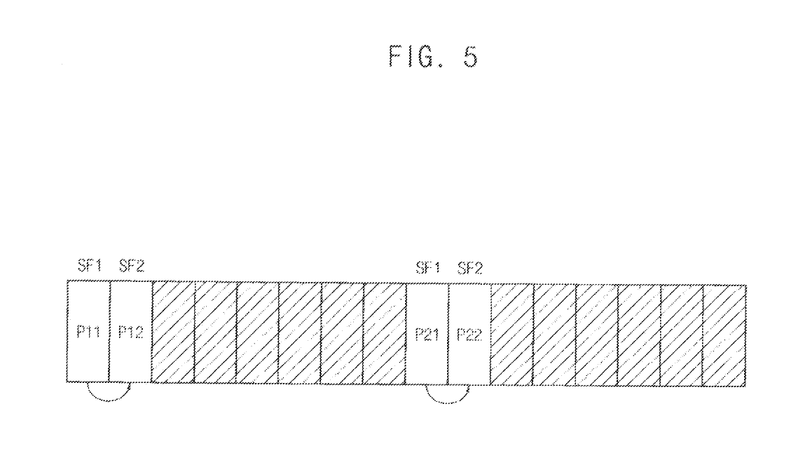

FIG. 4A is a conceptual diagram illustrating a method of displaying the 3D image using the display panel 100 and the light converting element 200 of FIG. 1 during a first subframe SF1. FIG. 4B is a conceptual diagram illustrating a method of displaying the 3D image using the display panel 100 and the light converting element 200 of FIG. 1 during a second subframe SF2. FIG. 5 is a conceptual diagram illustrating an operation of the light converting element 200 of FIG. 1 during the first and second subframes SF1 and SF2.

For convenience of explanation, the images transmitted to the first viewpoint area V1 are illustrated in FIGS. 4A and 4B.

Referring to FIGS. 4A, 4B and 5, a first barrier B11 of a first unit barrier group and a first barrier B21 of a second unit barrier group have transmitting statuses during a first subframe SF1.

During the first subframe SF1, an image on the first subpixel P11 is transmitted to the first viewpoint area V1 through the first barrier B11 of the first unit barrier group having the transmitting status. An image on the ninth subpixel P21 is transmitted to the first viewpoint area V1 through the first barrier B21 of the second unit barrier group having the transmitting status.

The barrier having the transmitting status during the second subframe SF2 may be spaced apart from the barrier having the transmitting status during the first subframe SF1 by an integer multiple of the pitch of the barrier PB/8.

In the present exemplary embodiment, the barrier having the transmitting status during the second subframe SF2 is spaced apart from the barrier having the transmitting status during the first subframe SF1 by the pitch of the barrier PB/8.

Thus, a second barrier B12 of the first unit barrier group and a second barrier B22 of the second unit barrier group have transmitting statuses during the second subframe SF2.

During the second subframe SF2, an image on the second subpixel P12 is transmitted to the first viewpoint area V1 through the second barrier B12 of the first unit barrier group having the transmitting status. An image on the tenth subpixel P22 is transmitted to the first viewpoint area V1 through the second barrier B22 of the second unit barrier group having the transmitting status.

During the first subframe SF1, the images on the first and ninth subpixels P11 and P21 are shown to an eye of the viewer located at the first viewpoint area V1. During the second subframe SF2, the images on the second and tenth subpixels P12 and P22 are shown to the eye of the viewer located at the first viewpoint area V1. Thus, a resolution of the 3D image may be doubled because two different images are shown to the eye of the viewer.

When the single frame is divided into two time-division subframes, positions of two barriers in the unit barrier group having transmitting statuses in the frame may be same in consecutive frames.

For example, during a first subframe of a first frame, the first barrier B11, B21 in the unit barrier group has the transmitting status. During a second subframe of the first frame, the second barrier B12, B22 in the unit barrier group has the transmitting status. In the same way, during a first subframe of a second frame, the first barrier B11, B21 in the unit barrier group has the transmitting status. During a second subframe of the second frame, the second barrier B12, B22 in the unit barrier group has the transmitting status.

When the single frame is divided into two time-division subframes, positions of two barriers in the unit barrier group having transmitting statuses in the frame may be different from each other in consecutive frames.

For example, the barriers may have the transmitting statuses in turn in the subframes. For example, during a first subframe of a first frame, the first barrier B11, B21 in the unit barrier group has the transmitting status. During a second subframe of the first frame, the second barrier B12, B22 in the unit barrier group has the transmitting status. During a first subframe of a second frame, a third barrier B13, B23 in the unit barrier group has the transmitting status. During a second subframe of the second frame, a fourth barrier B14, B24 in the unit barrier group has the transmitting status. During a first subframe of a third frame, a fifth barrier B15, B25 in the unit barrier group has the transmitting status. During a second subframe of the third frame, a sixth barrier B16, B26 in the unit barrier group has the transmitting status. During a first subframe of a fourth frame, a seventh barrier B17, B27 in the unit barrier group has the transmitting status. During a second subframe of the second frame, an eighth barrier B18, B28 in the unit barrier group has the transmitting status.

For example, the barriers may have the transmitting statuses randomly in the subframes. For example, during a first subframe of a first frame, the first barrier B11, B21 in the unit barrier group has the transmitting status. During a second subframe of the first frame, the second barrier B12, B22 in the unit barrier group has the transmitting status. During a first subframe of a second frame, the fifth barrier B15, B25 in the unit barrier group has the transmitting status. During a second subframe of the second frame, the sixth barrier B16, B26 in the unit barrier group has the transmitting status. During a first subframe of a third frame, the third barrier B13, B23 in the unit barrier group has the transmitting status. During a second subframe of the third frame, the fourth barrier B14, B24 in the unit barrier group has the transmitting status. During a first subframe of a fourth frame, the seventh barrier B17, B27 in the unit barrier group has the transmitting status. During a second subframe of the second frame, the eighth barrier B18, B28 in the unit barrier group has the transmitting status.

Although N is eight and M is two in the present exemplary embodiment, N and M are not limited thereto. N and M may vary. For example, M is equal to or less than N.

According to the present exemplary embodiment, the display panel 100 and the light converting element 200 are driven in a time division driving method while maintaining the viewpoint gap VG so that a resolution of the 3D image may increase without deteriorating a crosstalk.

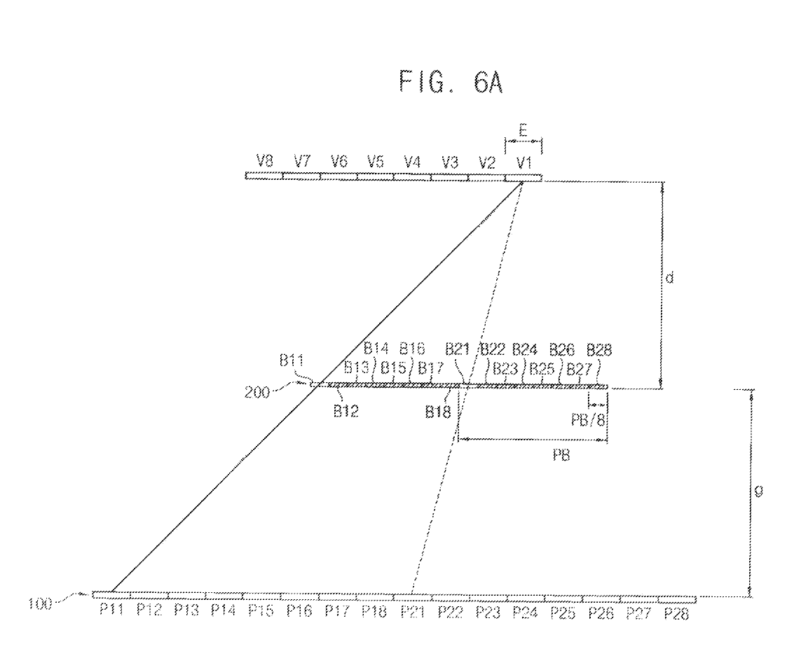

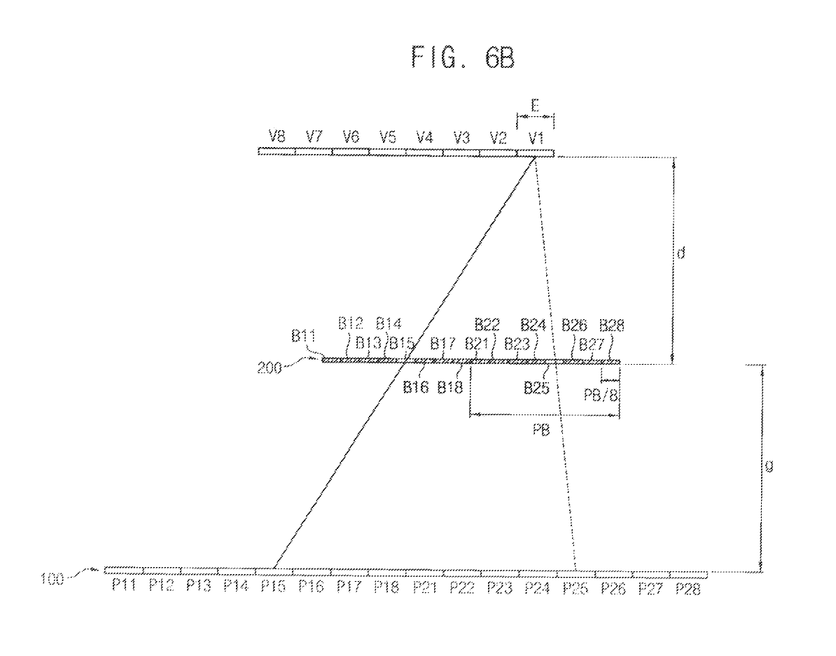

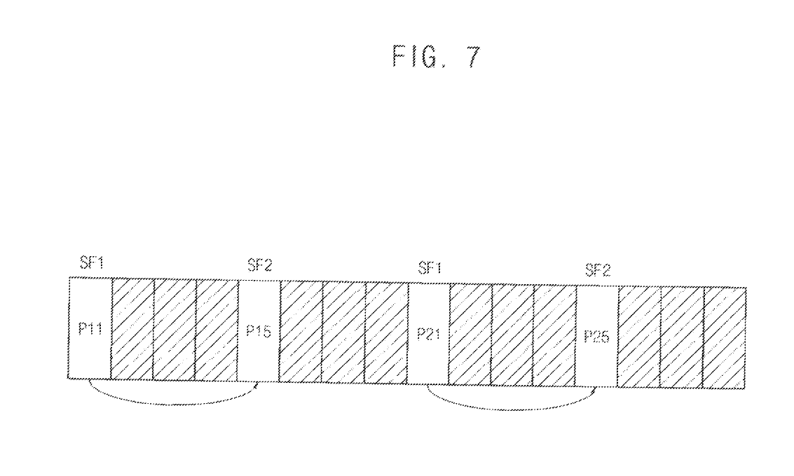

FIG. 6A is a conceptual diagram illustrating a method of displaying a 3D image using a display panel 100 and a light converting element 200 according to an exemplary embodiment during a first subframe SF1. FIG. 6B is a conceptual diagram illustrating a method of displaying the 3D image using the display panel 100 and the light converting element 200 of FIG. 6A during a second subframe SF2. FIG. 7 is a conceptual diagram illustrating an operation of the light converting element 200 of FIG. 6A during the first and second subframes SF1 and SF2.

A display apparatus and a method of displaying the 3D image according to the present exemplary embodiment are substantially the same as the display apparatus and the method of displaying the 3D image of the previous exemplary embodiment explained referring to FIGS. 1 to 5 except for an operation of the light converting element 200. Thus, the same reference numerals will be used to refer to the same or like parts as those described in the previous exemplary embodiment of FIGS. 1 to 5 and any repetitive explanation concerning the above elements will be omitted.

Referring to FIGS. 1, 6A, 6B and 7, the display apparatus includes a display panel 100, a light converting element 200, a display panel driver 300 and a light converting element driver 400.

The light converting element 200 is the barrier part and the light converting element driver 400 is the barrier driver in the present exemplary embodiment.

The barrier part 200 generates N viewpoint images using a plurality of barriers. In the present exemplary embodiment, N is eight. The display panel 100 and the barrier part 200 are driven in a time division driving method. For example, a single frame is divided into M subframes in the time division driving method. In the present exemplary embodiment, M is two.

The display panel 100 includes a plurality of subpixels. In FIGS. 6A and 6B, sixteen subpixels P11, P12, P13, P14, P15, P16, P17, P18, P21, P22, P23, P24, P25, P26, P27 and P28 are illustrated for convenience of explanation.

The barrier part 200 is disposed on the display panel 100. The barrier part 200 includes a unit barrier group including eight barriers (N=8). A pitch of the unit barrier group is PB. A pitch of the single barrier is equal to or greater than PB/8. For example, the pitch of the single barrier is PB/8. The eight barriers in the unit barrier group may be independently driven.

The image displayed on the subpixel of the display panel 100 is transmitted to viewpoint areas V1, V2, V3, V4, V5, V6, V7 and V8 through the barrier having a transmitting status.

For convenience of explanation, the images transmitted to the first viewpoint area V1 are illustrated in FIGS. 6A and 6B.

A first barrier B11 of a first unit barrier group and a first barrier B21 of a second unit barrier group have transmitting statuses during a first subframe SF1.

During the first subframe SF1, an image on the first subpixel P11 is transmitted to the first viewpoint area V1 through the first barrier B11 of the first unit barrier group having the transmitting status. An image on the ninth subpixel P21 is transmitted to the first viewpoint area V1 through the first barrier B21 of the second unit barrier group having the transmitting status.

The barrier having the transmitting status during the second subframe SF2 may be spaced apart from the barrier having the transmitting status during the first subframe SF1 by an integer multiple of the pitch of the barrier PB/8.

The barriers having the transmitting statuses may be evenly distributed in the unit barrier group in the subframes.

When the single frame is divided into M subframes, the barrier having the transmitting status during the second subframe SF2 may be spaced apart from the barrier having the transmitting status during the first subframe SF1 by an integer multiple of the pitch of the barrier PB/8. The integer may be a closest integer to N/M.

In the present exemplary embodiment, N is eight and M is two so that the barrier having the transmitting status during the second subframe SF2 is spaced apart from the barrier having the transmitting status during the first subframe SF1 by four times of the pitch of the barrier PB/8.

Thus, a fifth barrier B15 of the first unit barrier group and a fifth barrier B25 of the second unit barrier group have transmitting statuses during a second subframe SF2.

During the second subframe SF2, an image on the fifth subpixel P15 is transmitted to the first viewpoint area V1 through the fifth barrier B15 of the first unit barrier group having the transmitting status. An image on the thirteenth subpixel P25 is transmitted to the first viewpoint area V1 through the fifth barrier B25 of the second unit barrier group having the transmitting status.

During the first subframe SF1, the images on the first and ninth subpixels P11 and P21 are shown to an eye of the viewer located at the first viewpoint area V1. During the second subframe SF2, the images on the fifth and thirteenth subpixels P15 and P25 are shown to the eye of the viewer located at the first viewpoint area V1. Thus, a resolution of the 3D image may be doubled because two different images are shown to the eye of the viewer.

In addition, the image shown to the viewer during the first subframe SF1 and the image shown to the viewer during the second subframe SF2 are relatively evenly disposed in the display panel 100 so that the display quality of the 3D image may be improved.

When the single frame is divided into two time-division subframes, positions of two barriers in the unit barrier group having transmitting statuses in the frame may be same in consecutive frames.

For example, during a first subframe of a first frame, the first barrier B11, B21 in the unit barrier group has the transmitting status. During a second subframe of the first frame, the fifth barrier B15, B25 in the unit barrier group has the transmitting status. In the same way, during a first subframe of a second frame, the first barrier B11, B21 in the unit barrier group has the transmitting status. During a second subframe of the second frame, the fifth barrier B15, B25 in the unit barrier group has the transmitting status.

Alternatively, when the single frame is divided into two subframes, positions of two barriers in the unit barrier group having transmitting statuses in the frame may be different from each other in consecutive frames.

Although N is eight and M is two in the present exemplary embodiment, N and M are not limited thereto. N and M may vary. For example, M is equal to or less than N.

According to the present exemplary embodiment, the display panel 100 and the light converting element 200 are driven in a time division driving method while maintaining the viewpoint gap VG so that a resolution of the 3D image may increase without deteriorating a crosstalk.

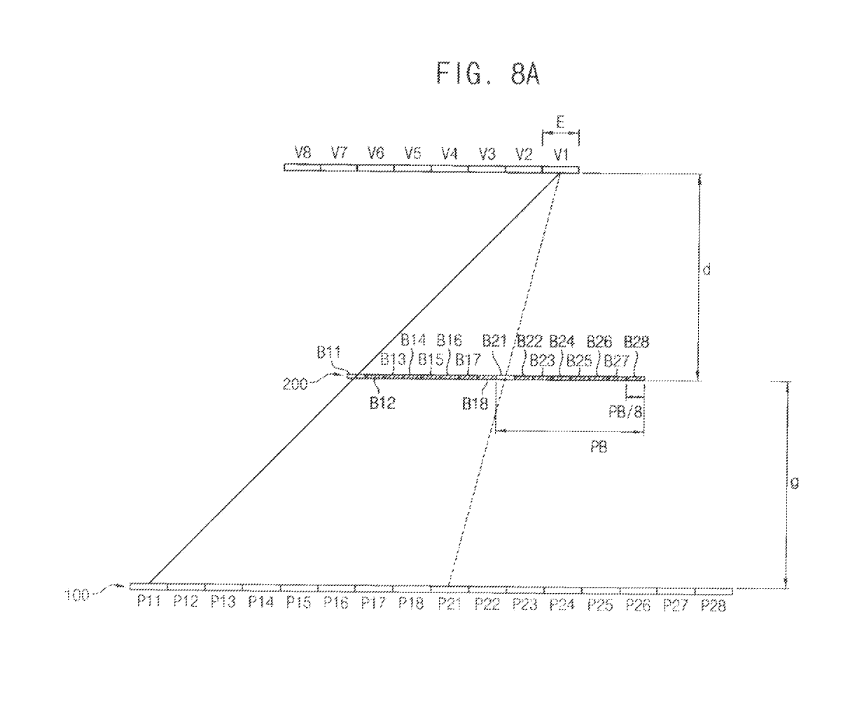

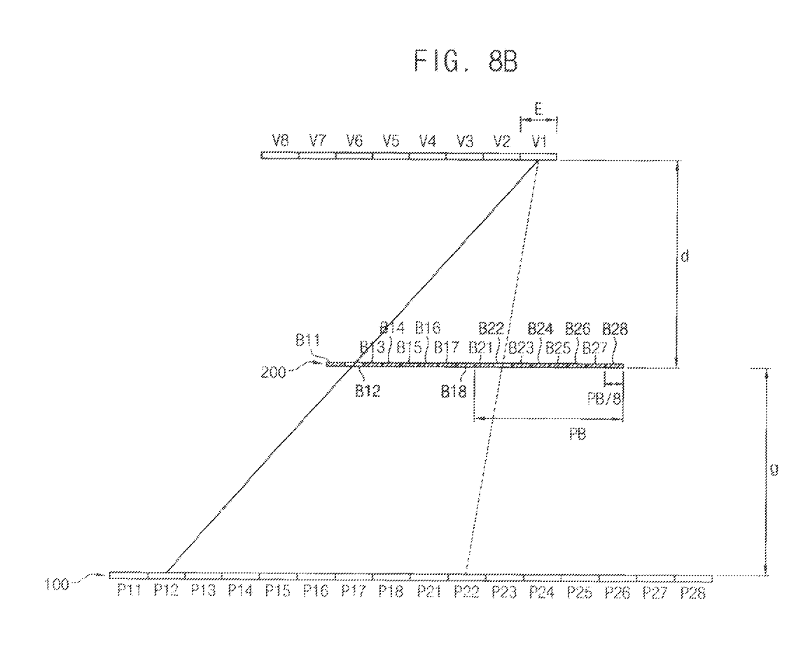

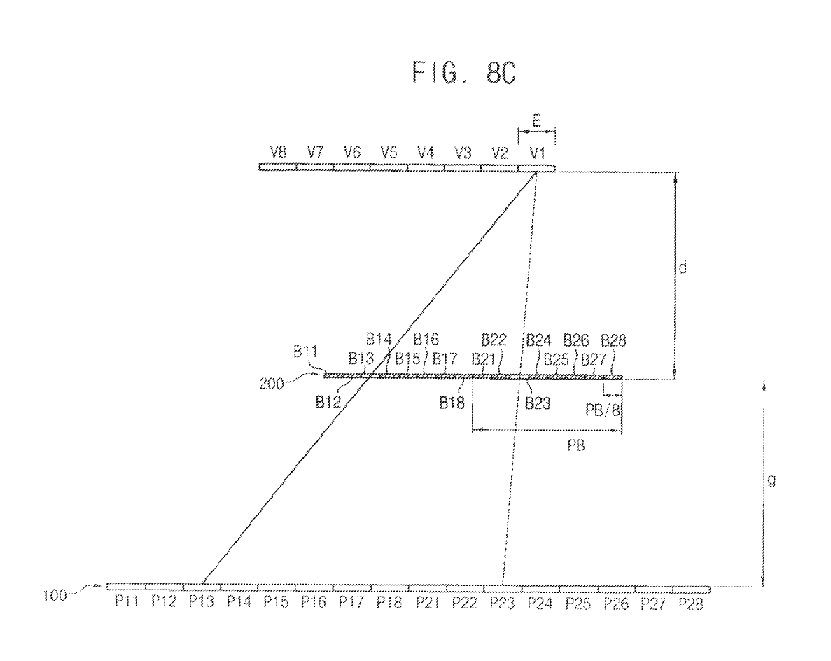

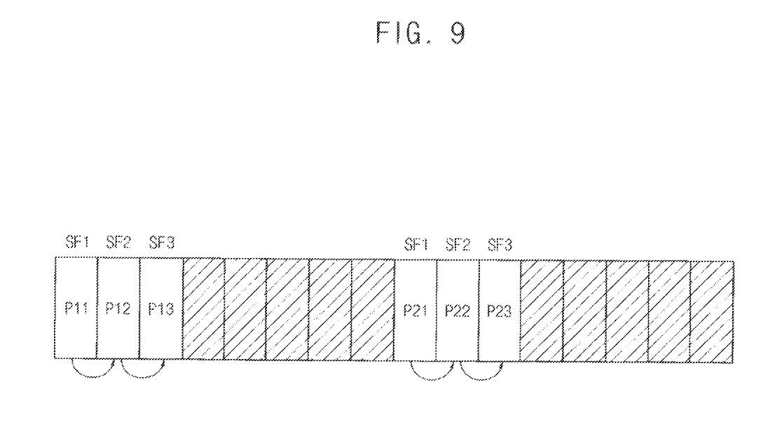

FIG. 8A is a conceptual diagram illustrating a method of displaying a 3D image using a display panel 100 and a light converting element 200 according to an exemplary embodiment during a first subframe SF1. FIG. 8B is a conceptual diagram illustrating a method of displaying the 3D image using the display panel 100 and the light converting element 200 of FIG. 8A during a second subframe SF2. FIG. 8C is a conceptual diagram illustrating a method of displaying the 3D image using the display panel 100 and the light converting element 200 of FIG. 8A during a third subframe SF3. FIG. 9 is a conceptual diagram illustrating an operation of the light converting element 200 of FIG. 8A during the first to third subframes SF1 to SF3.

A display apparatus and a method of displaying the 3D image according to the present exemplary embodiment are substantially the same as the display apparatus and the method of displaying the 3D image of the previous exemplary embodiment explained referring to FIGS. 1 to 5 except that a single frame is divided into three subframes to drive the display panel 100 and the light converting element 200. Thus, the same reference numerals will be used to refer to the same or like parts as those described in the previous exemplary embodiment of FIGS. 1 to 5 and any repetitive explanation concerning the above elements will be omitted.

Referring to FIGS. 1, 8A, 8B, 8C and 9, the display apparatus includes a display panel 100, a light converting element 200, a display panel driver 300 and a light converting element driver 400.

The light converting element 200 is the barrier part and the light converting element driver 400 is the barrier driver in the present exemplary embodiment.

The barrier part 200 generates N viewpoint images using a plurality of barriers. In the present exemplary embodiment, N is eight. The display panel 100 and the barrier part 200 are driven in a time division driving method. For example, a single frame is divided into M subframes in the time division driving method. In the present exemplary embodiment, M is three.

The display panel 100 includes a plurality of subpixels. In FIGS. 8A to 8C, sixteen subpixels P11, P12, P13, P14, P15, P16, P17, P18, P21, P22, P23, P24, P25, P26, P27 and P28 are illustrated for convenience of explanation.

The barrier part 200 is disposed on the display panel 100. The barrier part 200 includes a unit barrier group including eight barriers (N=8). A pitch of the unit barrier group is PB. A pitch of the single barrier is equal to or greater than PB/8. For example, the pitch of the single barrier is PB/8. The eight barriers in the unit barrier group may be independently driven.

The image displayed on the subpixel of the display panel 100 is transmitted to viewpoint areas V1, V2, V3, V4, V5, V6, V7 and V8 through the barrier having a transmitting status.

For convenience of explanation, the images transmitted to the first viewpoint area V1 are illustrated in FIGS. 8A to 8C.

A first barrier B11 of a first unit barrier group and a first barrier B21 of a second unit barrier group have transmitting statuses during a first subframe SF1.

During the first subframe SF1, an image on the first subpixel P11 is transmitted to the first viewpoint area V1 through the first barrier B11 of the first unit barrier group having the transmitting status. An image on the ninth subpixel P21 is transmitted to the first viewpoint area V1 through the first barrier B21 of the second unit barrier group having the transmitting status.

The barrier having the transmitting status during the second subframe SF2 may be spaced apart from the barrier having the transmitting status during the first subframe SF1 by an integer multiple of the pitch of the barrier PB/8.

In the present exemplary embodiment, the barrier having the transmitting status during the second subframe SF2 is spaced apart from the barrier having the transmitting status during the first subframe SF1 by the pitch of the barrier PB/8.

Thus, a second barrier B12 of the first unit barrier group and a second barrier B22 of the second unit barrier group have transmitting statuses during the second subframe SF2.

During the second subframe SF2, an image on the second subpixel P12 is transmitted to the first viewpoint area V1 through the second barrier B12 of the first unit barrier group having the transmitting status. An image on the tenth subpixel P22 is transmitted to the first viewpoint area V1 through the second barrier B22 of the second unit barrier group having the transmitting status.

In the present exemplary embodiment, the barrier having the transmitting status during the third frame SF3 is spaced apart from the barrier having the transmitting status during the second subframe SF2 by the pitch of the barrier PB/8.

Thus, a third barrier B13 of the first unit barrier group and a third barrier B23 of the second unit barrier group have transmitting statuses during the third subframe SF3.

During the third subframe SF3, an image on the third subpixel P13 is transmitted to the first viewpoint area V1 through the third barrier B13 of the first unit barrier group having the transmitting status. An image on the eleventh subpixel P23 is transmitted to the first viewpoint area V1 through the third barrier B23 of the second unit barrier group having the transmitting status.

During the first subframe SF1, the images on the first and ninth subpixels P11 and P21 are shown to an eye of the viewer located at the first viewpoint area V1. During the second subframe SF2, the images on the second and tenth subpixels P12 and P22 are shown to the eye of the viewer located at the first viewpoint area V1. During the third subframe SF3, the images on the third and eleventh subpixels P13 and P23 are shown to the eye of the viewer located at the first viewpoint area V1. Thus, a resolution of the 3D image may be tripled because three different images are shown to the eye of the viewer.

When the single frame is divided into three time-division subframes, positions of three barriers in the unit barrier group having transmitting statuses in the frame may be same in consecutive frames.

For example, during a first subframe of a first frame, the first barrier B11, B21 in the unit barrier group has the transmitting status. During a second subframe of the first frame, the second barrier B12, B22 in the unit barrier group has the transmitting status. During a third subframe of the first frame, the third barrier B13, B23 in the unit barrier group has the transmitting status. In the same way, during a first subframe of a second frame, the first barrier B11, B21 in the unit barrier group has the transmitting status. During a second subframe of the second frame, the second barrier B12, B22 in the unit barrier group has the transmitting status. During a third subframe of the second frame, the third barrier B13, B23 in the unit barrier group has the transmitting status.

Alternatively, when the single frame is divided into three subframes, positions of three barriers in the unit barrier group having transmitting statuses in the frame may be different from each other in consecutive frames.

Although N is eight and M is three in the present exemplary embodiment, N and M are not limited thereto. N and M may vary. For example, M is equal to or less than N.

According to the present exemplary embodiment, the display panel 100 and the light converting element 200 are driven in a time division driving method while maintaining the viewpoint gap VG so that a resolution of the 3D image may increase without deteriorating the crosstalk.

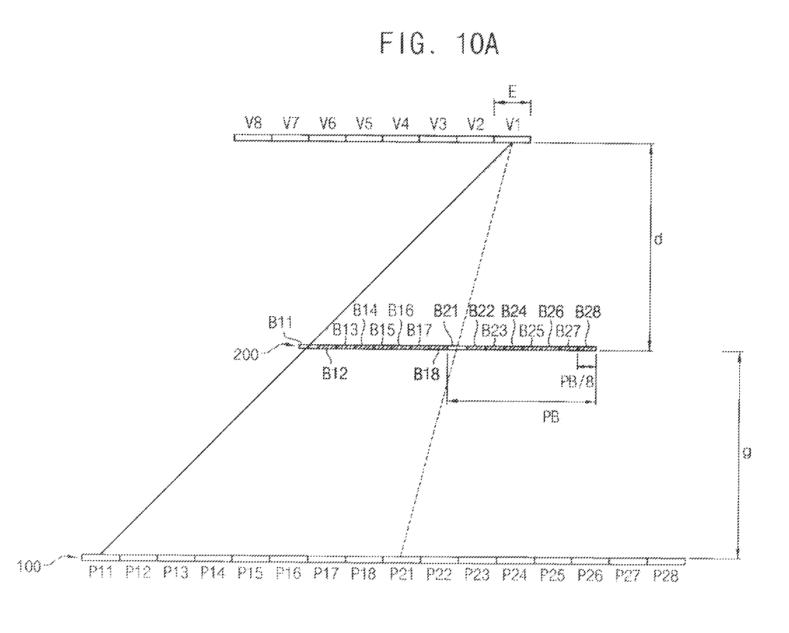

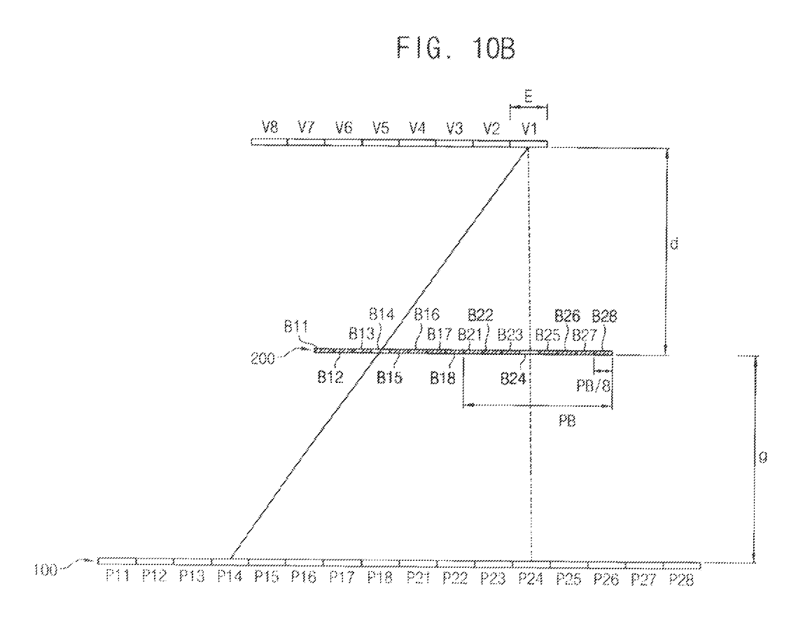

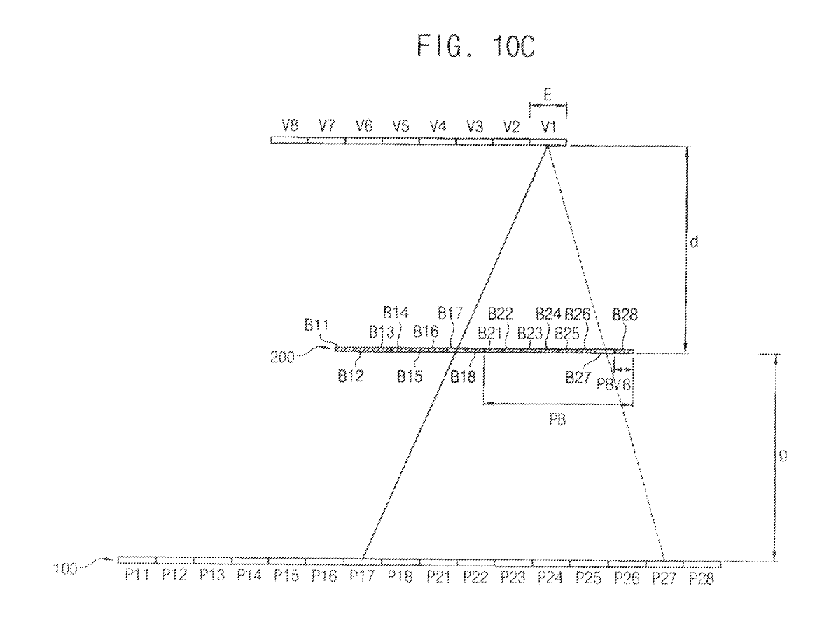

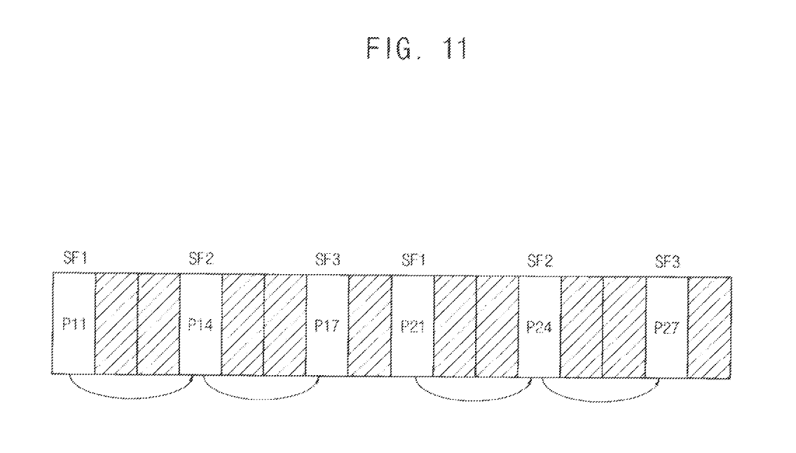

FIG. 10A is a conceptual diagram illustrating a method of displaying a 3D image using a display panel 100 and a light converting element 200 according to an exemplary embodiment during a first subframe SF1. FIG. 10B is a conceptual diagram illustrating a method of displaying the 3D image using the display panel 100 and the light converting element 200 of FIG. 10A during a second subframe SF2. FIG. 10C is a conceptual diagram illustrating a method of displaying the 3D image using the display panel 100 and the light converting element 200 of FIG. 10A during a third subframe SF3. FIG. 11 is a conceptual diagram illustrating an operation of the light converting element 200 of FIG. 10A during the first to third subframes SF1 to SF3.

A display apparatus and a method of displaying the 3D image according to the present exemplary embodiment are substantially the same as the display apparatus and the method of displaying the 3D image of the previous exemplary embodiment explained referring to FIGS. 8A to 8C except for an operation of the light converting element 200. Thus, the same reference numerals will be used to refer to the same or like parts as those described in the previous exemplary embodiment of FIGS. 8A to 8C and any repetitive explanation concerning the above elements will be omitted.

Referring to FIGS. 1, 10A, 10B, 10C and 11, the display apparatus includes a display panel 100, a light converting element 200, a display panel driver 300 and a light converting element driver 400.

The light converting element 200 is the barrier part and the light converting element driver 400 is the barrier driver in the present exemplary embodiment.

The barrier part 200 generates N viewpoint images using a plurality of barriers. In the present exemplary embodiment, N is eight. The display panel 100 and the barrier part 200 are driven in a time division driving method. For example, a single frame is divided into M subframes in the time division driving method. In the present exemplary embodiment, M is three.

The display panel 100 includes a plurality of subpixels. In FIGS. 10A to 10C, sixteen subpixels P11, P12, P13, P14, P15, P16, P17, P18, P21, P22, P23, P24, P25, P26, P27 and P28 are illustrated for convenience of explanation.

The barrier part 200 is disposed on the display panel 100. The barrier part 200 includes a unit barrier group including eight barriers (N=8). A pitch of the unit barrier group is PB. A pitch of the single barrier is equal to or greater than PB/8. For example, the pitch of the single barrier is PB/8. The eight barriers in the unit barrier group may be independently driven.

The image displayed on the subpixel of the display panel 100 is transmitted to viewpoint areas V1, V2, V3, V4, V5, V6, V7 and V8 through the barrier having a transmitting status.

For convenience of explanation, the images transmitted to the first viewpoint area V1 are illustrated in FIGS. 10A to 10C.

A first barrier B11 of a first unit barrier group and a first barrier B21 of a second unit barrier group have transmitting statuses during a first subframe SF1.

During the first subframe SF1, an image on the first subpixel P11 is transmitted to the first viewpoint area V1 through the first barrier B11 of the first unit barrier group having the transmitting status. An image on the ninth subpixel P21 is transmitted to the first viewpoint area V1 through the first barrier B21 of the second unit barrier group having the transmitting status.

The barrier having the transmitting status during the second subframe SF2 may be spaced apart from the barrier having the transmitting status during the first subframe SF1 by an integer multiple of the pitch of the barrier PB/8.

The barriers having the transmitting statuses may be evenly distributed in the unit barrier group in the subframes.

When the single frame is divided into M subframes, the barrier having the transmitting status during the second subframe SF2 may be spaced apart from the barrier having the transmitting status during the first subframe SF1 by an integer multiple of the pitch of the barrier PB/8. The integer may be a closest integer to N/M.

In the present exemplary embodiment, N is eight and M is three so that the barrier having the transmitting status during the second subframe SF2 is spaced apart from the barrier having the transmitting status during the first subframe SF1 by three times of the pitch of the barrier PB/8.

Thus, a fourth barrier B14 of the first unit barrier group and a fourth barrier B24 of the second unit barrier group have transmitting statuses during a second subframe SF2.

During the second subframe SF2, an image on the fourth subpixel P14 is transmitted to the first viewpoint area V1 through the fourth barrier B14 of the first unit barrier group having the transmitting status. An image on the twelfth subpixel P24 is transmitted to the first viewpoint area V1 through the fourth barrier B24 of the second unit barrier group having the transmitting status.

In the present exemplary embodiment, the barrier having the transmitting status during the third frame SF3 is spaced apart from the barrier having the transmitting status during the second subframe SF2 by three times of the pitch of the barrier PB/8.

Thus, a seventh barrier B17 of the first unit barrier group and a seventh barrier B27 of the second unit barrier group have transmitting statuses during the third subframe SF3.

During the third subframe SF3, an image on the seventh subpixel P17 is transmitted to the first viewpoint area V1 through the seventh barrier B17 of the first unit barrier group having the transmitting status. An image on the fifteenth subpixel P27 is transmitted to the first viewpoint area V1 through the seventh barrier B27 of the second unit barrier group having the transmitting status.

During the first subframe SF1, the images on the first and ninth subpixels P11 and P21 are shown to an eye of the viewer located at the first viewpoint area V1. During the second subframe SF2, the images on the fourth and twelfth subpixels P14 and P24 are shown to the eye of the viewer located at the first viewpoint area V1. During the third subframe SF3, the images on the seventh and fifteenth subpixels P17 and P27 are shown to the eye of the viewer located at the first viewpoint area V1. Thus, a resolution of the 3D image may be tripled.

In addition, the image shown to the viewer during the first subframe SF1, the image shown to the viewer during the second subframe SF2 and the image shown to the viewer during the third subframe SF3 are relatively evenly distributed in the display panel 100 so that the display quality of the 3D image may be improved.

When the single frame is divided into three subframes, positions of three barriers in the unit barrier group having transmitting statuses in the frame may be same in consecutive frames.

For example, during a first subframe of a first frame, the first barrier B11, B21 in the unit barrier group has the transmitting status. During a second subframe of the first frame, the fourth barrier B14, B24 in the unit barrier group has the transmitting status. During a third subframe of the first frame, the seventh barrier B17, B27 in the unit barrier group has the transmitting status. In the same way, during a first subframe of a second frame, the first barrier B11, B21 in the unit barrier group has the transmitting status. During a second subframe of the second frame, the fourth barrier B14, B24 in the unit barrier group has the transmitting status. During a third subframe of the second frame, the seventh barrier B17, B27 in the unit barrier group has the transmitting status.

Alternatively, when the single frame is divided into three subframes, positions of three barriers in the unit barrier group having transmitting statuses in the frame may be different from each other in consecutive frames.

Although N is eight and M is three in the present exemplary embodiment, N and M are not limited thereto. N and M may vary. For example, M is equal to or less than N.

According to the present exemplary embodiment, the display panel 100 and the light converting element 200 are driven in a time division driving method while maintaining the viewpoint gap VG so that a resolution of the 3D image may increase without deteriorating the crosstalk.

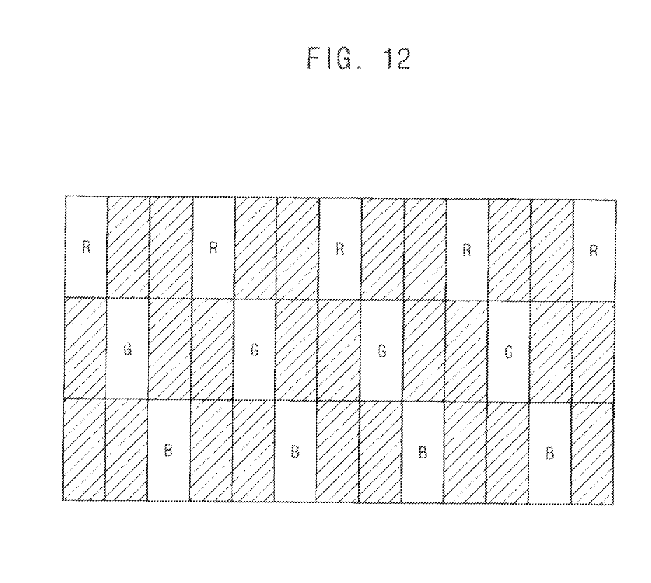

FIG. 12 is a conceptual diagram illustrating a displayed image using a display panel 100 and a light converting element 200 according to an exemplary embodiment.

A display apparatus and a method of displaying the 3D image according to the present exemplary embodiment are substantially the same as the display apparatus and the method of displaying the 3D image of the previous exemplary embodiment explained referring to FIGS. 1 to 5 except for a shape of the light converting element 200. Thus, the same reference numerals will be used to refer to the same or like parts as those described in the previous exemplary embodiment of FIGS. 1 to 5 and any repetitive explanation concerning the above elements will be omitted.

Referring to FIGS. 1 to 5 and 12, the display apparatus includes a display panel 100, a light converting element 200, a display panel driver 300 and a light converting element 400.

The light converting element 200 is disposed on the display panel 100. The light converting element 200 generates N viewpoint images based on an image on the display panel 100. Herein, N is a natural number. For example, the light converting element 200 may transmit the image on the subpixel of the display panel 100 to the respective viewpoints so that the viewer may recognize a three dimensional image.

The light converting element 200 is the barrier part and the light converting element driver 400 is the barrier driver in the present exemplary embodiment.

For example, the barriers selectively transmit and block the image on the subpixel of the display panel 100 so that the barriers generate N viewpoint images.

In the present exemplary embodiment, the barrier part 200 is a step barrier. The step barrier includes a barrier having the transmitting status in a first row and a barrier having the transmitting status in a second row. A position of the barrier having the transmitting status in the first row does not correspond to a position of the barrier having the transmitting status in the second row.

For example, during the first subframe, first, fourth, seventh and tenth barriers have the transmitting statuses in the first row of the barrier part 200. During the first subframe, second, fifth, eighth and eleventh barriers have the transmitting statuses in the second row of the barrier part 200. During the first subframe, third, sixth, ninth and twelfth barriers have the transmitting statuses in the third row of the barrier part 200.

During the second subframe, the barriers may have the transmitting statuses different from the barriers having the transmitting statuses during the first subframe. Specifically, the barriers are driven in a method which is one of the method explained referring to FIGS. 4A and 4B, the method explained referring to FIGS. 6A and 6B, the method explained referring to FIGS. 8A to 8C and the method explained referring to FIGS. 10A to 10C.

If the barriers having the transmitting status extend in a vertical direction and the red subpixels, the green pixels and the blue pixels in the display apparatus extend in the vertical direction, an image shown to the eye of the viewer at each subframe may have only one color according to N and M values. Thus, a color breakup may be occurred.

For example, when N is 3 and M is 3, only red subpixels are shown to the eye of the viewer during the first subframe, only green subpixels are shown to the eye of the viewer during the second subframe, and only blue subpixels are shown to the eye of the viewer during the third subframe.

As shown in FIG. 12, when the barrier part 200 has the step barrier shape, red, blue and green subpixels are evenly shown to the eye of the viewer so that the color breakup may be prevented.

According to the present exemplary embodiment, the display panel 100 and the light converting element 200 are driven in a time division driving method while maintaining the viewpoint gap VG so that a resolution of the 3D image may increase without deteriorating the crosstalk.

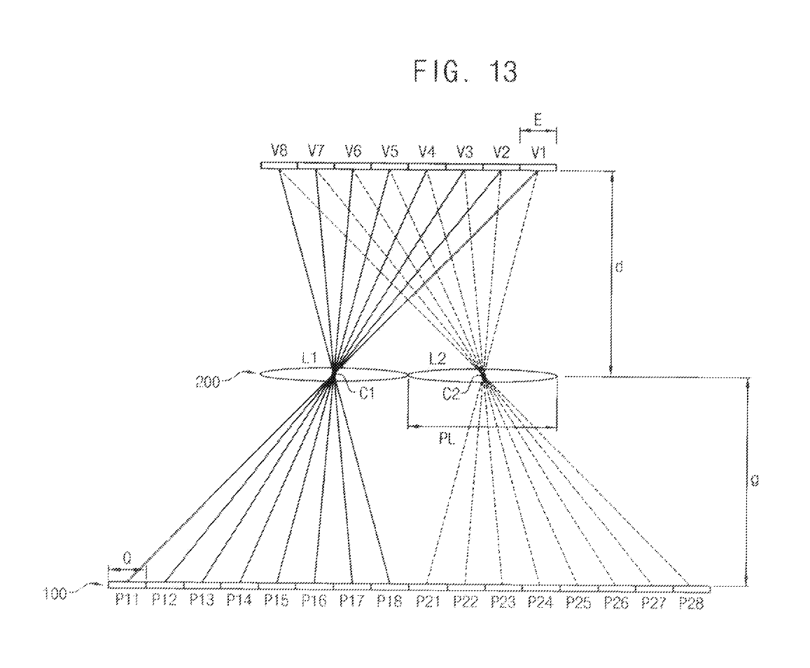

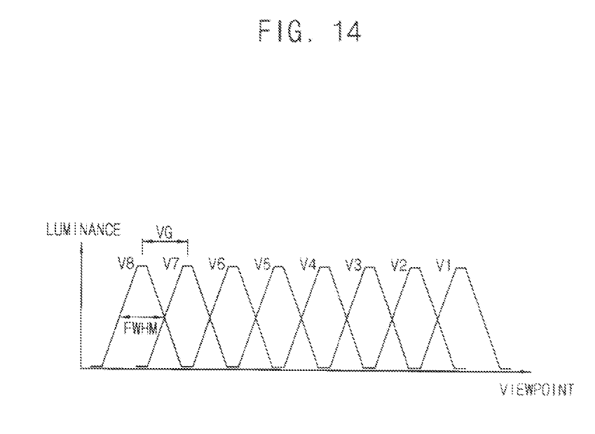

FIG. 13 is a conceptual diagram illustrating a method of displaying a 3D image using a display panel 100 and a light converting element 200 according to an exemplary embodiment. FIG. 14 is a graph illustrating a luminance profile of the 3D image displayed using the display panel 100 and the light converting element 200 of FIG. 13 according to viewpoints.

A display apparatus and a method of displaying the 3D image according to the present exemplary embodiment are substantially the same as the display apparatus and the method of displaying the 3D image of the previous exemplary embodiment explained referring to FIGS. 1 to 5 except that the light converting element 200 is a lens part. Thus, the same reference numerals will be used to refer to the same or like parts as those described in the previous exemplary embodiment of FIGS. 1 to 5 and any repetitive explanation concerning the above elements will be omitted.

Referring to FIGS. 1, 13 and 14, the display apparatus includes a display panel 100, a light converting element 200, a display panel driver 300 and a light converting element driver 400.

The light converting element 200 is a lens part and the light converting element driver 400 is a lens driver in the present exemplary embodiment.

The light converting element 200 includes a plurality of lenticular lenses. The lenticular lenses refract light. The lenticular lenses may refract the image on the subpixel of the display panel 100 so that the lenticular lenses generate N viewpoint images. The lenticular lenses may be disposed along a first direction. The lenticular lenses may extend in a second direction crossing the first direction.

The lens part 200 generates N viewpoint images using a plurality of the lenticular lenses. In the present exemplary embodiment, N is eight. The display panel 100 and the lens part 200 are driven in a time division driving method. For example, a single frame is divided into M subframes in the time division driving method. In the present exemplary embodiment, M is two.

The display panel 100 includes a plurality of subpixels. In FIG. 13, sixteen subpixels P11, P12, P13, P14, P15, P16, P17, P18, P21, P22, P23, P24, P25, P26, P27 and P28 are illustrated for convenience of explanation.

The lens part 200 is disposed on the display panel 100. The single lens corresponds to eight subpixels of the display panel 100. A pitch of the lens is PL.

The image displayed on the subpixel of the display panel 100 is transmitted to viewpoint areas V1, V2, V3, V4, V5, V6, V7 and V8 through the lens.

For example, an image on a first subpixel P11 is transmitted to a first viewpoint area V1 through a central portion C1 of a first lens L1. An image on a second subpixel P12 is transmitted to a second viewpoint area V2 through the central portion C1 of the first lens L1. An image on a third subpixel P13 is transmitted to a third viewpoint area V3 through the central portion C1 of the first lens L1. An image on a fourth subpixel P14 is transmitted to a fourth viewpoint area V4 through the central portion C1 of the first lens L1. An image on a fifth subpixel P15 is transmitted to a fifth viewpoint area V5 through the central portion C1 of the first lens L1. An image on a sixth subpixel P16 is transmitted to a sixth viewpoint area V6 through the central portion C1 of the first lens L1. An image on a seventh subpixel P17 is transmitted to a seventh viewpoint area V7 through the central portion C1 of the first lens L1. An image on an eighth subpixel P18 is transmitted to an eighth viewpoint area V8 through the central portion C1 of the first lens L1.

In a similar way, an image on a ninth subpixel P21 is transmitted to the first viewpoint area V1 a central portion C2 of a second lens L2. An image on a tenth subpixel P22 is transmitted to the second viewpoint area V2 through the central portion C2 of the second lens L2. An image on an eleventh subpixel P23 is transmitted to the third viewpoint area V3 through the central portion C2 of the second lens L2. An image on a twelfth subpixel P24 is transmitted to the fourth viewpoint area V4 through the central portion C2 of the second lens L2. An image on a thirteenth subpixel P25 is transmitted to the fifth viewpoint area V5 through the central portion C2 of the second lens L2. An image on a fourteenth subpixel P26 is transmitted to the sixth viewpoint area V6 through the central portion C2 of the second lens L2. An image on a fifteenth subpixel P27 is transmitted to the seventh viewpoint area V7 through the central portion C2 of the second lens L2. An image on a sixteenth subpixel P28 is transmitted to then eighth viewpoint area V8 through the central portion C2 of the second lens L2.

When a distance between the display panel 100 and the lens part 200 is g, a proper distance from the lens part 200 to the viewer is d, a pitch of the subpixel of the display panel 100 is Q, a pitch of the lens is PL and a width of the viewpoint area at the proper distance from the barrier part 200 to the viewer d is E, the display apparatus satisfies following Equations 3 and 4.

PL:d=8Q:(d+g) [Equation 3]

E:d=Q:g [Equation 4]

FIG. 14 represents a luminance profile according to the viewpoint of the 3D image. The luminance of the image corresponding to the first viewpoint has the maximum value at a central portion of the first viewpoint area V1. The luminance of the image corresponding to the first viewpoint decreases as a position is deviated from the central portion of the first viewpoint area V1.

The luminance of the image corresponding to the second viewpoint has the maximum value at the central portion of the second viewpoint area V2. The luminance of the image corresponding to the second viewpoint decreases as a position is deviated from the central portion of the second viewpoint area V2.

The luminance of the image corresponding to the third viewpoint has the maximum value at the central portion of the third viewpoint area V3. The luminance of the image corresponding to the third viewpoint decreases as a position is deviated from the central portion of the third viewpoint area V3.

As a ratio of the FWHM of the luminance to the viewpoint gap VG increases, a probability of a crosstalk increases. In the present exemplary embodiment, although the display panel 100 and the light converting element 200 are driven in the time division driving method, the viewpoint gap VG is not changed. Thus, the display apparatus according to the exemplary embodiments of the invention has a relatively low value of the ratio. Thus, the crosstalk may be prevented.

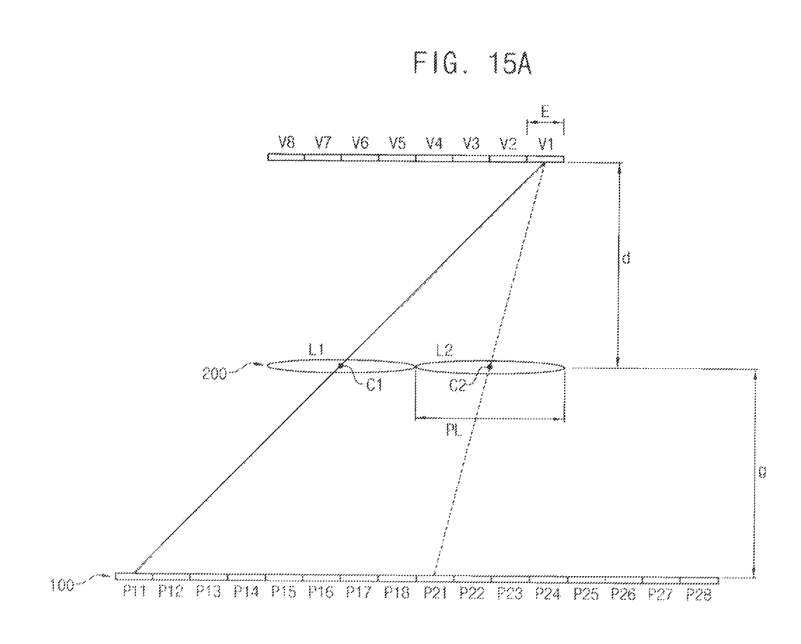

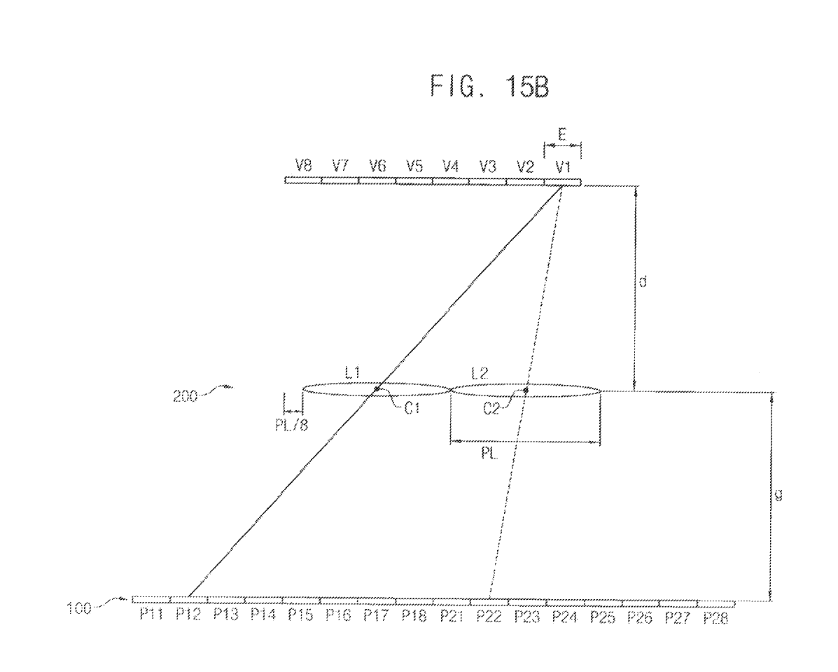

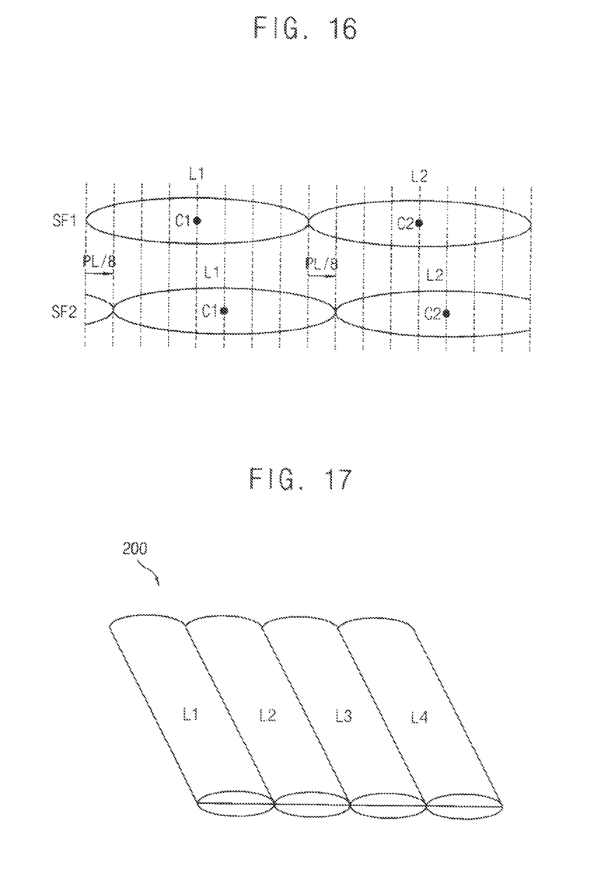

FIG. 15A is a conceptual diagram illustrating a method of displaying a 3D image using a display panel 100 and a light converting element 200 of FIG. 13 during a first subframe SF1. FIG. 15B is a conceptual diagram illustrating a method of displaying the 3D image using the display panel 100 and the light converting element 200 of FIG. 13 during a second subframe SF2. FIG. 16 is a conceptual diagram illustrating an operation of the light converting element 200 of FIG. 13 during the first and second subframes SF1 and SF2.

For convenience of explanation, the images transmitted to the first viewpoint area V1 are illustrated in FIGS. 15A and 15B.

Referring to FIGS. 15A, 15B and 16, the lens part 200 is disposed at a first position during a first subframe SF1.

During the first subframe SF1, an image on the first subpixel P11 is transmitted to the first viewpoint area V1 through the central portion C1 of the first lens L1. An image on the ninth subpixel P21 is transmitted to the first viewpoint area V1 through the central portion C2 of the second lens L2.

The lens part 200 in the second subframe SF2 has a different lens shape than that of the first subframe SF1. As a result, the focal point of the lens part 200 in the second subframe SF2 is different from the focal point of the lens part 200 in the first subframe SF1.

The focal point of lenses L1 and L2 in the second subframe SF2 are shifted from the focal point of the lenses L1 and L2 in the first sub frame SF1 by an integer multiple of PL/N.

In the present exemplary embodiment, the lenses L1 and L2 in the second subframe SF2 are shifted from the focal point of the lenses L1 and L2 in the first sub frame SF1 by PL/8.

During the second subframe SF2, an image on the second subpixel P12 is transmitted to the first viewpoint area V1 through the central portion C1 of the first lens L1. An image on the tenth subpixel P22 is transmitted to the first viewpoint area V1 through the central portion C2 of the second lens L2.

During the first subframe SF1, the images on the first and ninth subpixels P11 and P21 are shown to an eye of the viewer located at the first viewpoint area V1. During the second subframe SF2, the images on the second and tenth subpixels P12 and P22 are shown to the eye of the viewer located at the first viewpoint area V1. Thus, a resolution of the 3D image may be doubled.

When the single frame is divided into two subframes, two positions of the lens part 200 in the frame may be same in consecutive frames.

For example, during a first subframe of a first frame, the lens part 200 is disposed at a first position. During a second subframe of the first frame, the lens part 200 is disposed at a second position which is shifted from the first position by PL/8. In the same way, during a first subframe of a second frame, the lens part 200 is disposed at the first position. During a second subframe of the first frame, the lens part 200 is disposed at the second position.

When the single frame is divided into two time division subframes, two positions of the lens part 200 in the frame may be different from each other in consecutive frames.

For example, the lens part 200 may be shifted in turn in the subframes. For example, during a first subframe of a first frame, the lens part 200 is disposed at a first position. During a second subframe of the first frame, the lens part 200 is disposed at a second position which is shifted from the first position by PL/8. During a first subframe of a second frame, the lens part 200 is disposed at a third position which is shifted from the second position by PL/8. During a second subframe of the second frame, the lens part 200 is disposed at a fourth position which is shifted from the third position by PL/8.

For example, the lens part 200 may evenly displace in the frame. For example, during a first subframe of a first frame, the lens part 200 is disposed at a first position. During a second subframe of the first frame, the lens part 200 is disposed at a second position which is shifted from the first position by the PL/8. During a first subframe of a second frame, the lens part 200 is disposed at a third position which is shifted from the second position by an integer multiple of PL/8. During a second subframe of the second frame, the lens part 200 is disposed at a fourth position which is shifted from the third position by PL/8.

The previous exemplary embodiment explained referring to FIGS. 6A and 6B may be applied to the present exemplary embodiment including the lens part as the light converting element 200. In the previous exemplary embodiment in FIGS. 6A and 6B, N is eight and M is two.

Specifically, during the first subframe SF1, an image on the first subpixel P11 is transmitted to the first viewpoint area V1 through the first lens L1. An image on the ninth subpixel P21 is transmitted to the first viewpoint area V1 through the second lens L2.

The lens part 200 may be shifted evenly distributed in the pitch PL of the lens in the subframes.

For example, when the single frame is divided into M subframes, the lenses L1 and L2 are disposed at a position during the second subframe SF2 moved from the position of the lenses L1 and L2 during the first subframe SF1 by an integer multiple of PL/N. The integer may be a closest integer to N/M.

In the present exemplary embodiment, N is eight and M is two so that the position of the lenses L1 and L2 during the second subframe SF2 are moved from the position of the lenses L1 and L2 during the first subframe SF1 by four times of PL/8.

During the second subframe SF2, an image on the fifth subpixel P15 is transmitted to the first viewpoint area V1 through the first lens L1. An image on the thirteenth subpixel P25 is transmitted to the first viewpoint area V1 through the second lens L2.

The previous exemplary embodiment explained referring to FIGS. 8A to 8C may be applied to the present exemplary embodiment including the lens part as the light converting element 200. In the previous exemplary embodiment in FIGS. 8A to 8C, N is eight and M is three.

Specifically, during the first subframe SF1, an image on the first subpixel P11 is transmitted to the first viewpoint area V1 through the first lens L1. An image on the ninth subpixel P21 is transmitted to the first viewpoint area V1 through the second lens L2.

In the present exemplary embodiment, the position of the lenses L1 and L2 during the second subframe SF2 are moved from the position of the lenses L1 and L2 during the first subframe SF1 by PL/8.

During the second subframe SF2, an image on the second subpixel P12 is transmitted to the first viewpoint area V1 through the first lens L1. An image on the tenth subpixel P22 is transmitted to the first viewpoint area V1 through the second lens L2.

In the present exemplary embodiment, the position of the lenses L1 and L2 during the third subframe SF3 are moved from the position of the lenses L1 and L2 during the second subframe SF2 by PL/8.

During the third subframe SF3, an image on the third subpixel P13 is transmitted to the first viewpoint area V1 through the first lens L1. An image on the eleventh subpixel P23 is transmitted to the first viewpoint area V1 through the second lens L2.

The previous exemplary embodiment explained referring to FIGS. 10A to 10C may be applied to the present exemplary embodiment including the lens part as the light converting element 200. In the previous exemplary embodiment in FIGS. 6A and 6B, N is eight and M is three.

Specifically, during the first subframe SF1, an image on the first subpixel P11 is transmitted to the first viewpoint area V1 through the first lens L1. An image on the ninth subpixel P21 is transmitted to the first viewpoint area V1 through the second lens L2.

The lens part 200 may be shifted evenly in the pitch PL of the lens in the subframes.

For example, when the single frame is divided into M subframes, the lenses L1 and L2 are disposed at a position during the second subframe SF2 moved from the position of the lenses L1 and L2 during the first subframe SF1 by an integer multiple of PL/N. The integer may be a closest integer to N/M.

In the present exemplary embodiment, N is eight and M is three so that the position of the lenses L1 and L2 during the second subframe SF2 are shifted from the position of the lenses L1 and L2 during the first subframe SF1 by three times of PL/8.

During the second subframe SF2, an image on the fourth subpixel P14 is transmitted to the first viewpoint area V1 through the first lens L1. An image on the twelfth subpixel P24 is transmitted to the first viewpoint area V1 through the second lens L2.

In the present exemplary embodiment, N is eight and M is three so that the position of the lenses L1 and L2 during the third subframe SF3 are moved from the position of the lenses L1 and L2 during the second subframe SF2 by three times of PL/8.

During the third subframe SF3, an image on the seventh subpixel P17 is transmitted to the first viewpoint area V1 through the first lens L1. An image on the fifteenth subpixel P27 is transmitted to the first viewpoint area V1 through the second lens L2.

According to the present exemplary embodiment, the display panel 100 and the light converting element 200 are driven in a time division driving method while maintaining the viewpoint gap VG so that a resolution of the 3D image may increase without deteriorating the crosstalk.

FIG. 17 is a perspective view illustrating a light converting element according to an exemplary embodiment.

A display apparatus and a method of displaying the 3D image according to the present exemplary embodiment are substantially the same as the display apparatus and the method of displaying the 3D image of the previous exemplary embodiment explained referring to FIGS. 13 to 16 except for a shape of the light converting element 200. Thus, the same reference numerals will be used to refer to the same or like parts as those described in the previous exemplary embodiment of FIGS. 13 to 16 and any repetitive explanation concerning the above elements will be omitted.

Referring to FIGS. 13 to 17, the display apparatus includes a display panel 100, a light converting element 200, a display panel driver 300 and a light converting element 400.

The light converting element 200 is disposed on the display panel 100. The light converting element 200 generates N viewpoint images based on an image on the display panel 100. Herein, N is a natural number. For example, the light converting element 200 may transmit the image on the subpixel of the display panel 100 to the respective viewpoints.

The light converting element 200 is the lens part and the light converting element driver 400 is the lens driver in the present exemplary embodiment.

For example, the lens part 200 generates N viewpoint images using a plurality of lenses.

In the present exemplary embodiment, the lenses L1, L2, L3 and L4 of the lens part 200 may be inclined with respect to a direction of a pixel column.

The lens part 200 is disposed at a first position during a first subframe SF1. The lenses L1, L2, L3 and L4 are disposed at a position during the second subframe SF2 shifted from the position of the lenses L1, L2, L3 and L4 during the first sub frame SF1 by an integer multiple of PL/N.

If the lenses of the lens part 200 extend in a vertical direction and red subpixels, green subpixels and blue subpixels in the display apparatus extend in the vertical direction, an image shown to the eye of the viewer at each subframe may have only one color according to N and M values. Thus, a color breakup may be occurred.

For example, when N is 3 and M is 3, only red subpixels are shown to the eye of the viewer during the first subframe, only green subpixels are shown to the eye of the viewer during the second subframe, and only blue subpixels are shown to the eye of the viewer during the third subframe.

As shown in FIG. 17, when the lenses of the lens part 200 are inclined with respect to the direction of the pixel column, red, blue and green subpixels are evenly shown to the eye of the viewer so that the color breakup may be prevented.

According to the present exemplary embodiment, the display panel 100 and the light converting element 200 are driven in a time division driving method while maintaining the viewpoint gap VG so that a resolution of the 3D image may increase without deteriorating the crosstalk.

As explained above, according to the display apparatus and the method of displaying the 3D image of the present invention, the resolution of the 3D image may increase and a crosstalk may be prevented. Thus, a display quality of the 3D image may be increased.

The foregoing is illustrative of the present invention and is not to be construed as limiting thereof. Although a few exemplary embodiments of the present invention have been described, those skilled in the art will readily appreciate that many modifications are possible in the exemplary embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific exemplary embodiments disclosed, and that modifications to the disclosed exemplary embodiments, as well as other exemplary embodiments, are intended to be included within the scope of the appended claims. The present invention is defined by the following claims, with equivalents of the claims to be included therein.

What is claimed is:

1. A display apparatus comprising:
a display panel including a plurality of pixels;
a barrier part disposed on the display panel and generating N viewpoint images using a plurality of barriers selectively transmitting and blocking a light, N being a natural number;
a display panel driver providing image data to the display panel; and
a barrier driver controlling the barrier part such that the different barriers have transmitting statuses in a first subframe and a second subframe.

2. The display apparatus of claim 1, wherein the barrier part includes a unit barrier group having N barriers,
a pitch of the unit barrier group is P, and
a pitch of the barrier is equal to or greater than P/N.

3. The display apparatus of claim 2, wherein the barrier having the transmitting status during the second subframe is spaced apart from the barrier having the transmitting status during the first subframe by an integer multiple of the pitch of the barrier in the unit barrier group.

4. The display apparatus of claim 2, wherein when a single frame is divided into M subframes, M being a natural number, the barrier having the transmitting status during the second subframe is spaced apart from the barrier having the transmitting status during the first subframe by an integer multiple of the pitch of the barrier in the unit barrier group, and
the integer is a closest integer to N/M.

5. The display apparatus of claim 1, wherein when a single frame is divided into M subframes, M being a natural number, positions of barriers in the unit barrier group having transmitting statuses in the frame are same in consecutive frames.

6. The display apparatus of claim 1, wherein when a single frame is divided into M subframes, M being a natural number, positions of barriers in the unit barrier group having transmitting statuses in the frame are different from each other in consecutive frames.

7. The display apparatus of claim 1, wherein the barrier part is a liquid crystal barrier module which is turned off in a two-dimensional mode and turned on in a three-dimensional mode.

8. The display apparatus of claim 1, wherein the barrier part is a step barrier including a barrier having the transmitting status in a first row, a barrier having the transmitting status in a second row, and
a position of the barrier having the transmitting status in the first row does not correspond to a position of the barrier having the transmitting status in the second row.

9. A method of displaying a three-dimensional (“3D”) image, the method comprising:
providing image data to a display panel including a plurality of pixels; and
controlling a barrier part including a plurality of barriers selectively transmitting and blocking light such that the different barriers have transmitting statuses in a first subframe and a second subframe to generate N viewpoint images, N being a natural number.

10. The method of claim 9, wherein the barrier part includes a unit barrier group having N barriers,
a pitch of the unit barrier group is P, and
a pitch of the barrier is equal to or greater than P/N.

11. A display apparatus comprising:
a display panel including a plurality of pixels;
a lens part disposed on the display panel and generating N viewpoint images using a plurality of lenses refracting a light, N being a natural number;
a display panel driver providing image data to the display panel; and
a lens driver shifting a focal point of the lens part in a first subframe and a second subframe.

12. The display apparatus of claim 11, wherein a pitch of the lens is P,
the lens is disposed at a position during the second subframe which is shift from a position of the lens during the first sub frame by P/N.

13. The display apparatus of claim 11, wherein a pitch of the lens is P,
the lens is disposed at a position during the second subframe which is shifted from a position of the lens during the first subframe by an integer multiple of P/N.

14. The display apparatus of claim 13, wherein when a single frame is divided into M subframes, M being a natural number, the lens is disposed at a position during the second subframe which is moved from a position of the lens during the first subframe by an integer multiple of P/N, and
the integer is a closest integer to N/M.

15. The display apparatus of claim 11, wherein when a single frame is divided into M subframes, M being a natural number, positions of the lens part in the frame are same in consecutive frames.

16. The display apparatus of claim 11, wherein when a single frame is divided into M subframes, M being a natural number, positions of the lens part in the frame are different from each other in consecutive frames.

17. The display apparatus of claim 11, wherein the lens part is a liquid crystal lens module which is turned off in a two-dimensional mode and turned on in a three-dimensional mode.

18. The display apparatus of claim 11, wherein the lenses of the lens part are inclined with respect to a direction of a pixel column.

19. A method of displaying a three-dimensional (“3D”) image, the method comprising:
providing image data to a display panel including a plurality of pixels; and
controlling a lens part including a plurality of lenses refracting a light such that a focal point of the lenses are shifted in a first subframe and a second subframe to generate N viewpoint images, N being a natural number.

20. The method of claim 19, wherein a pitch of the lens is P,
the lens is disposed at a position during the second subframe which is shifted from the position of the lens during the first sub frame by P/N.

21. The method of claim 19, wherein a pitch of the lens is P,
the lens is disposed at a position during the second subframe which is shifted from a position of the lens during the first subframe by an integer multiple of P/N.
